(19) United States
(12) Patent Application Publication
(10) Pub. No.: US 2024/0351840 A1
(43) Pub. Date: Oct. 24, 2024

(54) TELESCOPIC FORKLIFT ROTATOR SYSTEM

(71) Applicant: HERC BUILD LLC, Bonita Springs, FL (US)

(72) Inventors: Brian DWIGHT, Lindsay (CA); Craig PRATT, Whitchurch-Stouffville (CA); David DWIGHT, Pickering (CA)

(21) Appl. No.: 18/640,551

(22) Filed: Apr. 19, 2024

Related U.S. Application Data
(60) Provisional application No. 63/461,193, filed on Apr. 21, 2023.

(51) Int. Cl. B66F 9/12; B66F 9/065; B66F 9/24

(52) U.S. Cl. CPC B66F 9/12; B66F 9/24; B66F 9/0655

(57) ABSTRACT

The present disclosure relates to a telescopic forklift rotator system comprising: (a) a frame comprising a top plate; a bottom plate positioned opposite the top plate and connected to the top plate by a plurality of side plates; a gusset connecting the side plates, wherein the frame is configured to house each component of the telescopic forklift rotator system, and wherein each side wall comprises a hole configured to secure a tilt drive assembly to the frame; (b) the tilt drive assembly comprising a tilt output left arm connected to a tilt output right arm through a shaft, each of the tilt output left arm and tilt output right arm comprising a tilt connector; and (c) a rotatable mount extending from the top plate in a direction pointing away from the bottom plate.

### CROSS-REFERENCE SECTION

This application claims priority to U.S. Provisional Application No. 63/461,193, filed on Apr. 21, 2023, which is incorporated by reference herein in its entirety for all purposes.

### FIELD OF THE DISCLOSURE

This application relates to a telescopic forklift rotator system for connecting a telescopic forklift to accessories while providing multiple axes of rotation for the accessories relative to the telescopic forklift.

### BACKGROUND

A telescopic forklift, or telehandler, is a heavy machine comprising a mobile base with a linear telescopic boom which can be raised and lowered. It is generally intended for moving objects from one position to another where extended reach is required. These machines are widely used in agriculture and construction. Due to their flexibility, they have been widely adopted by the film industry for temporarily suspending film related equipment. Items may include, but are not limited to, rain trusses, diffusion frames, lighting arrays or structural apparatuses.

However, once an object is affixed to an end of the boom, its orientation with respect to the boom is also fixed, providing little means to make adjustments without a tedious decoupling of the parts from each other. Existing technologies lack systems for connecting objects to telescopic handlers while providing positional adjustments across multiple axes of rotation that can be done remotely while the components are still connected.

### SUMMARY

According to one aspect of the present disclosure, a telescopic forklift rotator system is disclosed. It includes a frame including a top plate and a bottom plate positioned opposite the top plate and connected to the top plate by two side walls. The system may include a gusset connecting the two side walls, wherein the frame may be configured to house each component of the telescopic forklift rotator system. Each side wall may include a hole configured to secure a tilt drive assembly to the frame. The system may include the tilt drive assembly including a tilt output left arm connected to a tilt output right arm through a shaft, each of the tilt output left arm and tilt output right arm including a plurality of truss mounting plates configured to secure the telescopic forklift to a truss and provide a first axis of rotation for the truss relative to frame. The system may include a rotatable mount extending from the top plate in a direction pointing away from the bottom plate, the rotatable mount having a cylindrical body and at least one bolt connection port configured to secure the telescopic forklift to a connector including a fork-secure connector and a direct-attachment connector, wherein the rotatable mount provides a second axis of rotation for the connector relative to the frame. The system may include a motor mechanically connected to the frame, the tilt drive, and the rotatable mount.

The present disclosure relates to a telescopic forklift rotator system. The telescopic forklift rotator system may include a frame including a top plate; a bottom plate positioned opposite the top plate and connected to the top plate by a plurality of side plates; and a gusset connecting the side plates. The frame may be configured to house each component of the telescopic forklift rotator system, and wherein each side wall comprises a hole configured to secure a tilt drive assembly to the frame. The telescopic forklift rotator system may include the tilt drive assembly including a tilt output left arm connected to a tilt output right arm through a shaft, each of the tilt output left arm and tilt output right arm including a tilt connector, wherein the tilt drive assembly provides a first axis of rotation for the tile drive assembly relative to the frame. The telescopic forklift rotator system may include a rotatable mount extending from the top plate in a direction pointing away from the bottom plate, wherein the rotatable mount provides a second axis of rotation for the rotatable mount relative to the frame.

In some embodiments, the present disclosure relates to a telescopic forklift rotator system. The telescopic forklift rotator system may include a frame including a top plate; a bottom plate positioned opposite the top plate and connected to the top plate by a plurality of side plates. The frame may include a gusset connecting the side plates, wherein the frame may be configured to house each component of the telescopic forklift rotator system, and wherein each side wall comprises a hole configured to secure a tilt drive assembly to the frame. The telescopic forklift rotator system may include the tilt drive assembly including a tilt output left arm connected to a tilt output right arm through a shaft, each of the tilt output left arm and tilt output right arm including a tilt connector, wherein the tilt drive assembly provides a first axis of rotation for the tile drive assembly relative to the frame. The telescopic forklift rotator system may include a rotatable mount extending from the top plate in a direction pointing away from the bottom plate, wherein the rotatable mount comprises a cylindrical body and at least one bolt connection port and provides a second axis of rotation for the rotatable mount relative to the frame. The telescopic forklift rotator system may include a connector attached to the rotatable mount through the bolt connection port and configured to attach the telescopic forklift rotator system to a telescopic forklift.

In some embodiment, a tilt output left arm and tilt output right arm further comprises two or more connectors configured to secure a tilt drive assembly to a truss. A telescopic forklift rotator system may include a motor mechanically connected to a frame, a tilt drive, and a rotatable mount. The motor may be configured to provide mechanical power for rotating the truss relative to the frame and provide mechanical power for rotating the rotatable mount relative to the frame. The rotatable mount may include a cylindrical body and at least one bolt connection port. The telescopic forklift rotator system may include a direct-attachment connector attached to the rotatable mount. The direct-attachment connector may include a bottom plate connected to the rotatable mount through at least one bolt; a spacer plate connected to and extending outward from the bottom plate; and a pair of side plates connected to and extending outward form the bottom plate in a same direction as the spacer plate while the spacer plate runs perpendicular to and connects the pair of side plates, where the pair of side plates each includes a hook. A telescopic forklift rotator system may include including a fork-secure connector attached to the rotatable mount.

A fork-secure connector may include a rectangular prismatic frame including a bottom surface that connects to a rotatable mount; a plurality of fork plate gussets protruding outward from a top surface of the rectangular prismatic frame; and at least one tie down lug protruding outward from a side of the rectangular prismatic frame in a direction pointing away from the bottom surface, the tie down lug configured to attach to a chain. A telescopic forklift rotator system may include a battery attached to an inside surface of the frame and configured to provide electrical power to the motor. A telescopic forklift rotator system may include a controller module attached to an inside surface of a frame and may be configured to provide a user with control over each component of the telescopic forklift rotator system.

### BRIEF DESCRIPTION OF THE DRAWINGS

The disclosure is illustrated by way of example, and not by way of limitation, in the figures of the accompanying drawings in which like reference numerals are used to refer to similar elements. It is emphasized that various features may not be drawn to scale, and the dimensions of various features may be arbitrarily increased or reduced for clarity of discussion.

FIG. 1 illustrates a side perspective and a top perspective of a frame of a telescopic forklift rotator system, according to some embodiments of the disclosure.

FIG. 2A illustrates a side perspectives of a frame filled in with other components of a telescopic forklift rotator system, according to some embodiments of the disclosure.

FIG. 2B illustrates another side perspective of the frame of FIG. 2A, according to some embodiments of the disclosure.

FIG. 2C illustrates another side perspective of the frame of FIGS. 2A and 2B, according to some embodiments of the disclosure.

FIG. 3 illustrates the side perspective of a telescopic forklift rotator system attached to one of a universal fork secure connector and a direct-attachment connector, according to some embodiments of the disclosure.

FIG. 4 illustrates a front perspective of a telescopic forklift rotator system connected to a truss and a universal fork secure connector (multiple mounting positions are available to accommodate several truss sizes or plate configurations), according to some embodiments of the disclosure.

FIG. 5 illustrates a top perspective of a universal fork-secure connector, according to some embodiments of the disclosure.

FIG. 6 illustrates a front perspective of a direct-attachment connector, which is machine specific (multiple options available), according to some embodiments of the disclosure.

FIG. 7 illustrates a front perspective of a telescopic forklift rotator system control unit. This rapidly exchangeable module, (two bolts and six connectors) includes all of the electronics necessary to operate the unit for quick exchange in emergencies, according to some embodiments of the disclosure.

FIG. 8 illustrates a side perspective of a telescopic forklift rotator system accessory case, according to some embodiments of the disclosure.

FIG. 9 illustrates a front perspective of a telescopic forklift rotator system wired controller, according to some embodiments of the disclosure.

FIG. 10 illustrates a front perspective of a cable guide, according to some embodiments of the disclosure.

### DETAILED DESCRIPTION

The present disclosure relates to a telescopic forklift rotator system. A disclosed telescopic forklift rotator system may provide for multiple axes of rotation for objects attached to the telescopic forklift rotator system including a truss, a fork-secure connector, and a direct-attachment connector.

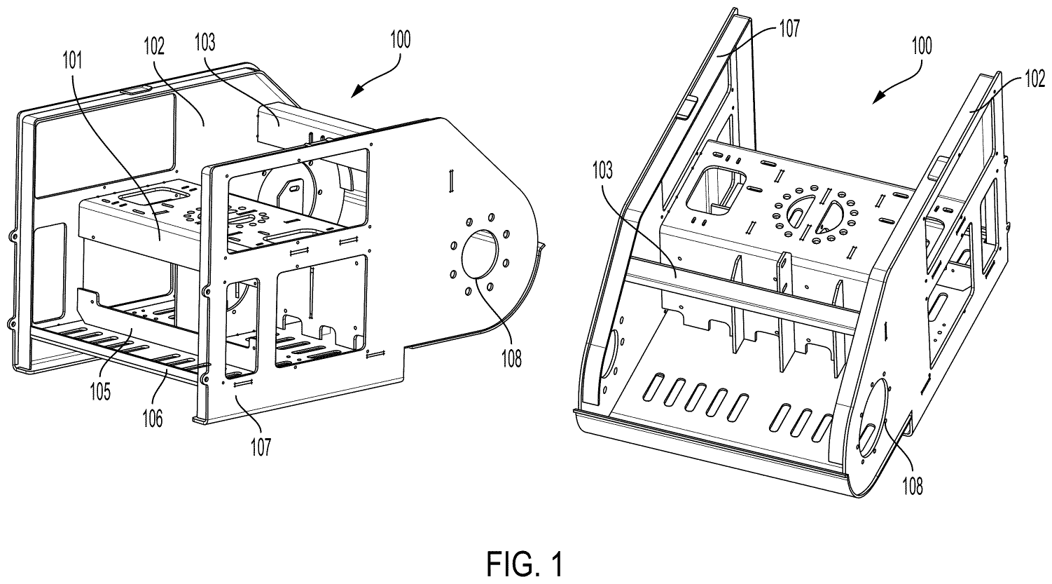

FIG. 1 illustrates a side perspective and a top perspective of a frame 100 of a telescopic forklift rotator system. The frame 100, as shown in FIG. 1, may encapsulate and support components of the telescopic forklift rotator system. The frame 100 may include a pan bearing plate 101 connected to a left side plate 102 and a right side plate 107. The pan bearing plate 101 may provide structural integrity to the frame 100 as well as support other components, including a rotatable mount, a pan drive assembly, and a controller module (not shown). As shown in FIG. 1, the frame 100 may include a bottom plate 106 that connects the left side plate 102 to the right side plate 107. The frame 100 may include one or more gussets 103, 105 that provide structural stability for the frame 100. The gussets 103, 105 may support components contained within the telescopic forklift rotator system as well as connect to each of the left side plate 102 and the right side plate 107.

According to some embodiments, as shown in FIG. 1, each of a left side plate 102 and a right side plate 107 of the frame 100 may include a hole 108. The hole 108 may be configured to secure a tilt drive assembly (not shown) to the frame 100. The holes 108 of the frame 100 may be configured to fit a tilt shaft (not shown) that may run through each of the holes 108. The holes 108 may be configured to each fit to an output arm (not shown).

In some embodiments, a frame 100 may be made of any known metal (e.g., steel, aluminum, or composite material). The frame 100 may be made of a polymer including a polyethylene, a polystyrene, a polyurethane, a nylon, a polypropylene, a polyethylene terephthalate, a polymethylmethacrylate, a polyacrylonitrile, a polyvinyl chloride, a polycarbonate, a silicone, a polyester, mixtures thereof, and copolymers thereof. The frame 100 may be made of a metal including a steel, a titanium, a brass, a copper, a lead, an iron, a bronze, an aluminum, a carbon steel, mixtures thereof, and alloys thereof. The frame 100 may be of any general shape, including a cube, a cuboid, a cylinder, a sphere, a cone, a pyramid, a torus, a hemisphere, a polyhedron, a triangular prism, a pentagonal prism, a hexagonal prism, mixtures thereof, and other. The frame 100 may have any general size, such as having at least one dimension (e.g., length, width, height, diameter, etc.) that is about 1 inch, or about 2 inches, or about 3 inches, or about 4 inches, or about 5 inches, or about 6 inches, or about 7 inches, or about 8 inches, or about 9 inches, or about 10 inches, or about 11 inches, or about 12 inches, or more, where about includes plus or minus 1 inch. The frame 100 may have any general size, such as having at least one dimension (e.g., length, width, height, diameter, etc.) that is about 1 foot, or about 2 feet, or about 3 feet, or about 4 feet, or about 5 feet, or about 6 feet, or about 7 feet, or about 8 feet, or about 9 feet, or about 10 feet, or about 11 feet, or about 12 feet, or more, where about includes plus or minus 1 foot. For example, a housing may have a cube shape, a height of about 4 feet, a length of about feet, and a width of about 4 feet.

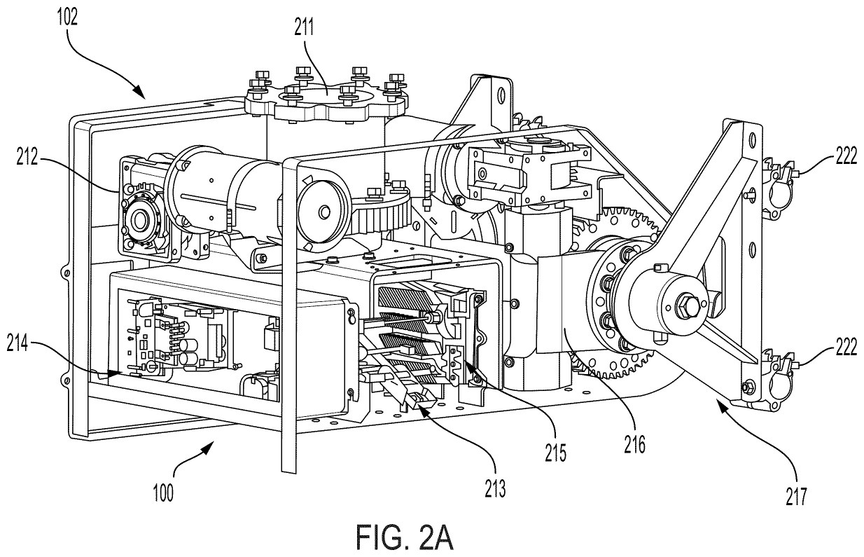

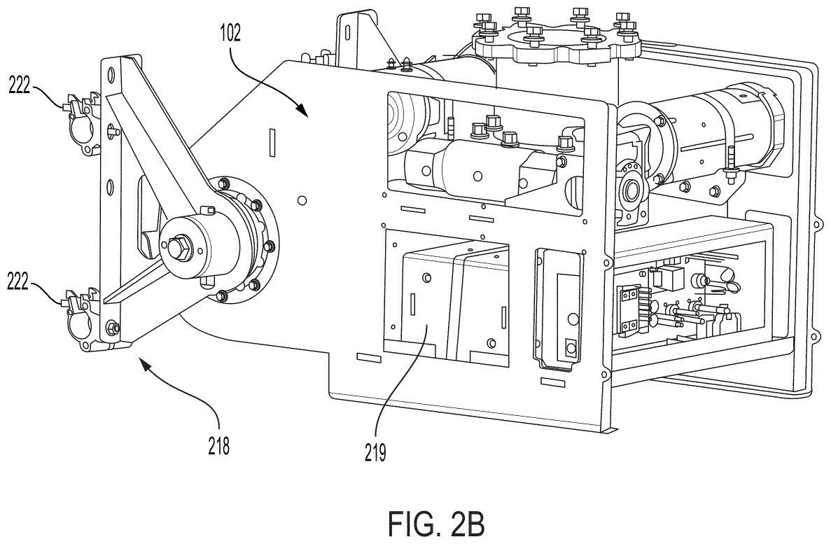

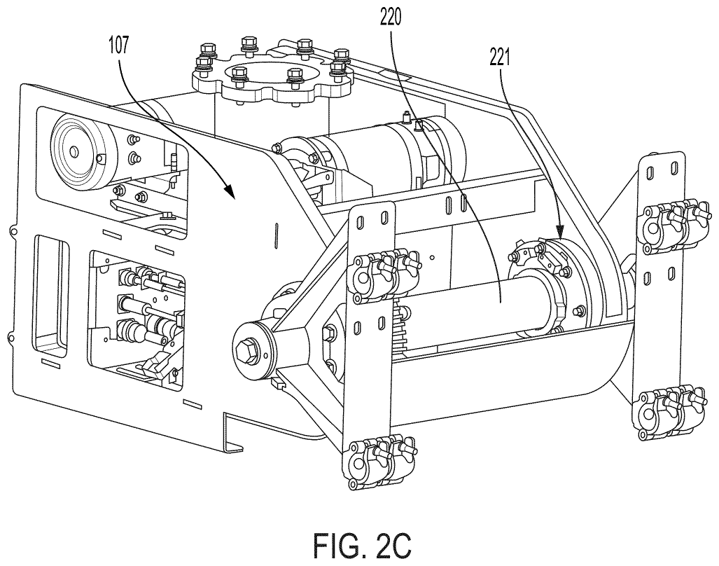

FIGS. 2A-2C illustrate various side perspectives of a disclosed frame 100 filled in with other components of a telescopic forklift rotator system. As shown in FIGS. 2A-2C, a frame 100 may be coupled to a pan drive assembly 212, a left side plate 102, a rotatable mount 211, a battery tie down 213, a battery assembly 219 including a battery, a controller module 214, and a battery charger 215. The battery tie down 213 may secure the battery assembly 219 and the battery charger 215 to the frame 100. The battery of the battery assembly 219 may include any known battery type, including a lead acid battery, a nickel metal hydride battery, an alkaline battery, a lithium battery, a carbon zinc battery, a lithium-ion battery, an electric battery, a gel battery, a nickel-based battery, a rechargeable battery, and others. The controller module 214 may be attached to an inside surface of the frame 100. The controller module 214 may be configured to provide a user with control over each component of the telescopic forklift rotator system. For example, the controller module may control a pan motor 223 and a tilt motor 224, each configured to provide mechanical power to either the rotatable mount 211 or the tilt output arms 217, 218. The battery assembly 219 may include a plurality of batteries. The battery of the battery assembly 219 may be configured to provide electrical power to either of the pan motor 223 or the tilt motor 224.

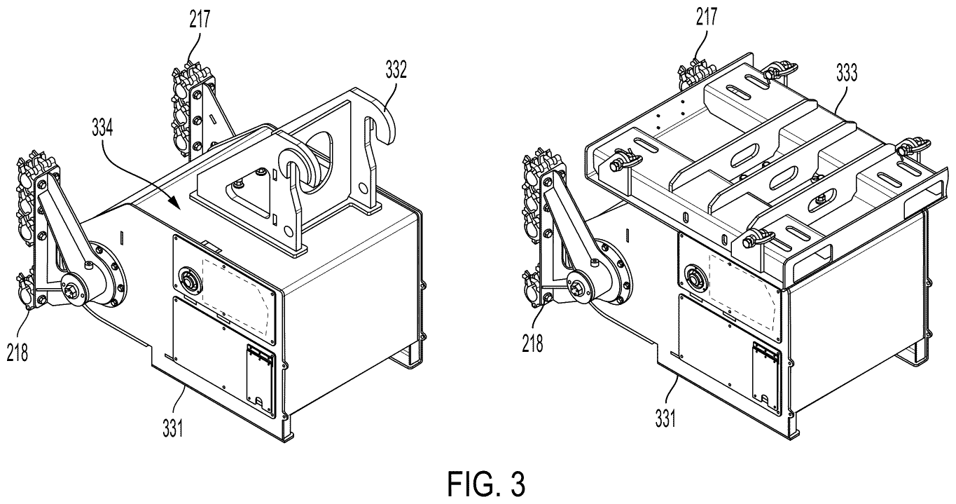

As shown in FIGS. 2A-2C, the frame 100 may include a rotatable mount 211. In some embodiments, the rotatable mount 211 may extend from a top portion of the frame 100 or a top plate (see FIG. 3) in a direction pointing away from the bottom plate (See 106 in FIG. 1). The rotatable mount 211 may provide for a second axis of rotation for the rotatable mount 211 relative to the frame 100. The rotatable mount 211 may be made of any metal (e.g., steel) or polymer (e.g., polyethylene). For example, the rotatable mount 211 may be made of a polymer including a polyethylene, a polystyrene, a polyurethane, a nylon, a polypropylene, a polyethylene terephthalate, a polymethylmethacrylate, a polyacrylonitrile, a polyvinyl chloride, a polycarbonate, a silicone, a polyester, mixtures thereof, and copolymers thereof. The rotatable mount 211 may be made of a metal including a steel, a titanium, a brass, a copper, a lead, an iron, a bronze, an aluminum, a carbon steel, mixtures thereof, and alloys thereof. The rotatable mount 211, as shown in FIGS. 2A-2C, has a generally cylindrical shape, but it may be other shapes. For example, the rotatable mount 211 may have any known general shape, including, but not limited to, a cube, a cuboid, a cylinder, a sphere, a cone, a pyramid, a torus, a hemisphere, a polyhedron, a triangular prism, a pentagonal prism, a hexagonal prism, a rectangular prism, mixtures thereof, and others. The rotatable mount 211 may be able to rotate at any general speed of rotation, including from about 0.5 rpm to about 100 rpm, or more. For example, the rotatable mount may be able to rotate at a speed of rotation of about 0.5 rpm, or about 1 rpm, or about 10 rpm, or about 20 rpm, or about 30 rpm, or about 40 rpm, or about 50 rpm, or about 60 rpm, or about 70 rpm, or about 80 rpm, or about 90 rpm, or about 100 rpm, where about includes plus or minus 5 rpm. The rotatable mount 211 may be configured to rotate any of clockwise or counterclockwise with respect to a face of the frame 100. The rotatable mount 211 may be able to generate a range of torques when rotating. For example, the rotatable mount 211 may be able to generate a torque of about 100 ft/lbs., or about 500 ft/lbs., or about 1,000 ft/lbs., or about 1,500 ft/lbs., or about 2,000 ft/lbs., or about 2,500 ft/lbs., or about 3,000 ft/lbs., or about 3,500 ft/lbs., or about 4,000 ft/lbs., or about 4,500 ft/lbs., or about 5,000 ft/lbs., or about 5,500 ft/lbs., or about 6,000 ft/lbs., or about 6,500 ft/lbs., or about 7,000 ft/lbs., or about 7,500 ft/lbs., or about 8,000 ft/lbs., or about 8,500 ft/lbs., or about 9,000 ft/lbs., or about 9,500 ft/lbs., or about 10,000 ft/lbs., or about, where about includes plus or minus 250 ft/lbs.

A frame 100 as shown in FIGS. 2A-2C may include a tilt drive assembly 216, a tilt output right arm 217, and a tilt output left arm 218. As shown in FIGS. 2A-2C, each of the tilt output left arm 218 and tilt output right arm 217 may include a tilt connector 222, wherein the tilt drive assembly 216 may provide for a first axis of rotation for the tile drive assembly 216 relative to the frame 100. As shown in FIGS. 2A-2C, a frame 100 may include a tilt shaft 220, and a tilt idler bearing 221. In some embodiments, each of the right arm 208 and left arm 209 may connect to a truss, providing rotation about the tilt shaft 220. Each of the right arm 217 and left arm 218 when rotating about the tilt shaft 220 may do so at a speed of rotation ranging from about 0.5 rpm to about 100 rpm. For example, the speed of rotation may be about 0.5 rpm, or about 1 rpm, or about 10 rpm, or about 20 rpm, or about 30 rpm, or about 40 rpm, or about 50 rpm, or about 60 rpm, or about 70 rpm, or about 80 rpm, or about 90 rpm, or about 100 rpm, where about includes plus or minus 5 rpm. Each of the right arm 208 and left arm 209 when rotating about the tilt shaft 220 may do so while producing a torque ranging from about 100 ft/lbs. to about 10,000 ft/lbs. For example, generated a torque may be of about 100 ft/lbs., or about 500 ft/lbs., or about 1,000 ft/lbs., or about 1,500 ft/lbs., or about 2,000 ft/lbs., or about 2,500 ft/lbs., or about 3,000 ft/lbs., or about 3,500 ft/lbs., or about 4,000 ft/lbs., or about 4,500 ft/lbs., or about 5,000 ft/lbs., or about 5,500 ft/lbs., or about 6,000 ft/lbs., or about 6,500 ft/lbs., or about 7,000 ft/lbs., or about 7,500 ft/lbs., or about 8,000 ft/lbs., or about 8,500 ft/lbs., or about 9,000 ft/lbs., or about 9,500 ft/lbs., or about 10,000 ft/lbs., or about, where about includes plus or minus 250 ft/lbs. In some embodiments, the advantages include remote positioning with speed control versus in situ mechanical adjustment.

Each of a right arm 208, left arm 209, and tilt shaft 220 may be made of any known metal (e.g., steel) or plastic (e.g., polyethylene). For example, each of the right arm 208, left arm 209, and tilt shaft 220 may be made of a polymer including a polyethylene, a polystyrene, a polyurethane, a nylon, a polypropylene, a polyethylene terephthalate, a polymethylmethacrylate, a polyacrylonitrile, a polyvinyl chloride, a polycarbonate, a silicone, a polyester, mixtures thereof, and copolymers thereof. The rotatable mount 211 may be made of a metal including a steel, a titanium, a brass, a copper, a lead, an iron, a bronze, an aluminum, a carbon steel, mixtures thereof, and alloys thereof.

FIG. 3 illustrates a side perspective of a telescopic forklift rotator system 331 attached to a connector including one of a direct-attachment connector 332 and a fork-secure connector 333, located above the top plate 334 of the telescopic forklift rotator system 331. A fork-secure connector 333, as shown in FIG. 3 may couple to the forks of a forklift (not shown). In some embodiments, a direct-attachment connector 332 may connect a telescopic forklift rotator system 331 directly to a boom of a forklift instead of requiring forks. In some embodiments, a disclosed system may provide for complete 360° rotation of the connector with respect to the telescopic forklift rotator system 331. For example, the direct-attachment connector 332 may rotate a full 360° about its connection to the telescopic forklift rotator system 331 in a clockwise or counter-clockwise manner.

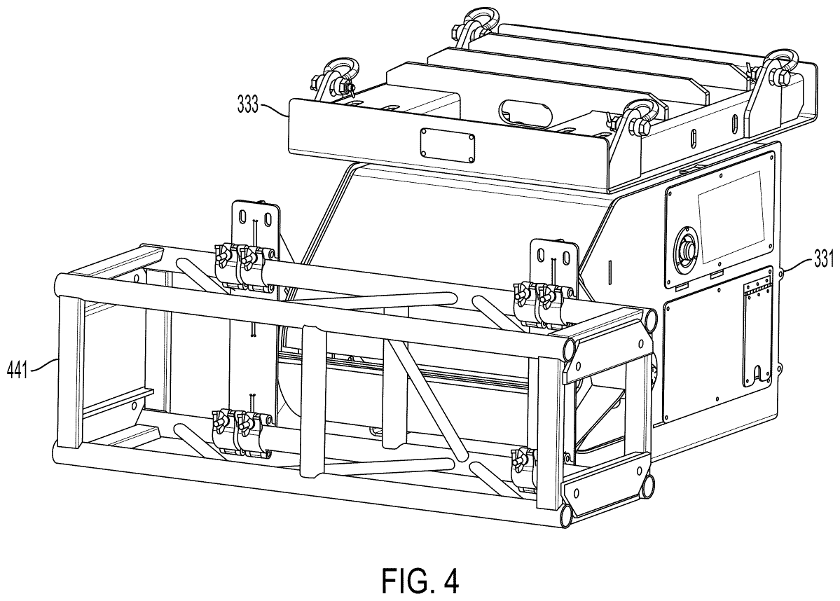

FIG. 4 illustrates a front perspective of a telescopic forklift rotator system 331 connected to a truss 441 and a fork-secure connector 333. The disclosed configuration of FIG. 4 provides but a single example of how the telescopic forklift rotator system 331 may connect to various components. In disclosed embodiments, output plates may provide multiple mounting options to accommodate several truss sizes mounted using industry standard pipe clamps or custom bolt on brackets. Two independent perpendicular axes of rotation may be provided, as described above through the connection of telescopic forklift rotator system 331 to either of the truss 441 or the fork-secure connector 333.

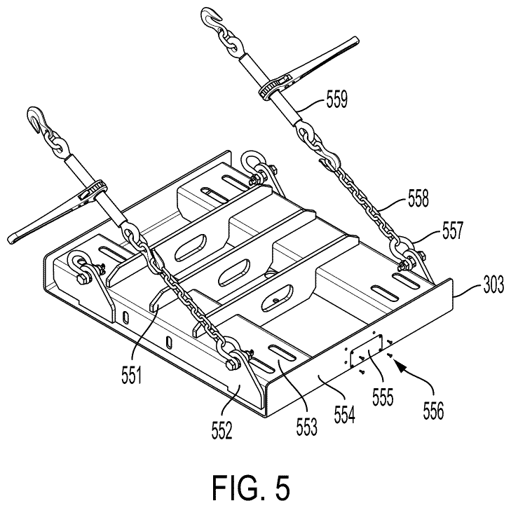

In some embodiments, a telescopic forklift rotator system may couple to a fork-secure connector through a rotatable mount. FIG. 5 illustrates a top perspective of a fork-secure connector 333. The fork-secure connector 333 may be coupled to a top of a telescopic forklift rotator system. The fork-secure connector 333 may include a fork plate gusset 551, a tie down lug 552, a fork pocket 553, an upper fork plate 554, and an ID label 555. The ID Label 555 may be configured to provide any structural and identity-based information about the fork-secure connector 333 or any equipment attached thereto. The ID Label 555 may include any known bar code, a radio frequency ID (RFID), a stamped tag, and others. The bottom of the fork-secure connector 333 may be bolted onto a rotatable mount of the disclosed telescopic forklift rotator system. The fork pocket 553 may receive one or more forks from a forklift to provide an attachment of the fork-secure connector 333 of the disclosed telescopic forklift rotator system to the forklift. In some embodiments, the fork-secure connector 333 may include a plurality of rivets 556 that may be made of metal (e.g., steel, aluminum). The fork-secure connector 333 may include one or more shackles 557 that may be rated at over a ton (e.g., 1.5 ton shackle). The fork-secure connector 333 may include a chain 558 and a chain binder 559.

In some embodiments, a fork-secure connector 333 may include a rectangular prismatic frame having a bottom surface that may connect to a rotatable mount of a telescopic forklift rotator system. The fork-secure connector 333 may include a plurality of fork plate gussets 551 protruding outward form a top surface of the rectangular prismatic frame. The fork plate gussets 551 may be made of any metal (e.g., steel) or polymer (e.g., polyethylene) and may be configured to engage with a fork of a forklift or to provide structural support of the fork-secure connector 333. The fork-secure connector 333 may include a plurality of tie down lugs 552 protruding outward from a side of the fork-secure connector 333 in a direction pointing away from the bottom surface, the tie down lugs 552 configured to attach to a shackle 557 connected to a chain 558.

While FIG. 5 depicts the fork-secure connector 333 having a generally rectangular prismatic frame, this is only one embodiment. The fork-secure connector 333 may have any known general shape, including, but not limited to, a cube, a cuboid, a cylinder, a sphere, a cone, a pyramid, a torus, a hemisphere, a polyhedron, a triangular prism, a pentagonal prism, a hexagonal prism, a rectangular prism, mixtures thereof, and others. The fork-secure connector 333 may have any general size, such as having at least one dimension (e.g., length, width, height, diameter, etc.) that is about 1 inch, or about 2 inches, or about 3 inches, or about 4 inches, or about 5 inches, or about 6 inches, or about 7 inches, or about 8 inches, or about 9 inches, or about 10 inches, or about 11 inches, or about 12 inches, or more, where about includes plus or minus 1 inch. The fork-secure connector 333 may have any general size, such as having at least one dimension (e.g., length, width, height, diameter, etc.) that is about 1 foot, or about 2 feet, or about 3 feet, or about 4 feet, or about 5 feet, or about 6 feet, or about 7 feet, or about 8 feet, or about 9 feet, or about 10 feet, or about 11 feet, or about 12 feet, or more, where about includes plus or minus 1 foot. For example, a housing may have a cube shape, a height of about 4 feet, a length of about feet, and a width of about 4 feet. The fork-secure connector 333 may be made of any metal (e.g., steel) or polymer (e.g., polyethylene). For example, the fork-secure connector 333 may be made of a polymer including a polyethylene, a polystyrene, a polyurethane, a nylon, a polypropylene, a polyethylene terephthalate, a polymethylmethacrylate, a polyacrylonitrile, a polyvinyl chloride, a polycarbonate, a silicone, a polyester, mixtures thereof, and copolymers thereof. The fork-secure connector 333 may be made of a metal including a steel, a titanium, a brass, a copper, a lead, an iron, a bronze, an aluminum, a carbon steel, mixtures thereof, and alloys thereof.

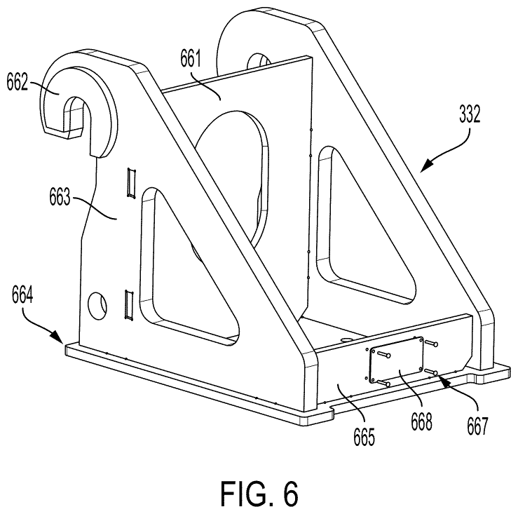

FIG. 6 illustrates a front perspective of a direct-attachment connector 332. The direct-attachment connector 332 may couple to a top of a telescopic forklift rotator system. For example, the direct-attachment connector 332 may connect to a rotatable mount of the telescopic forklift rotator system through one or more bolts. The direct-attachment connector 332 may advantageously couple a telescopic forklift rotator system to a forklift without the requirement of one or more forks. The direct-attachment connector 332 may include a spacer plate 661 that connects each of the side plates 663 while providing structural support for the direct-attachment connector 332. The spacer plate 661 may connect to and extend outward from a bottom plate 664. Similarly, the side plates 663 may attach to and extend outward from the bottom plate 664 in a same direction as the spacer plate 661, as shown in FIG. 6. The side plates may each contain a hook 662 configured to attach the direct-attachment connector 332 to a structure, including a truss. As shown in FIG. 6, the hook 662 may be reinforced by a reinforcing ring made of any metal (e.g., steel) or any plastic (e.g., polyethylene). The bottom plate 664 may be configured to be bolted onto a top plate of a disclosed telescopic forklift rotator system. The bottom plate 664 may connect to a rotatable mount through at least one bolt. The direct-attachment connector 332 may include a back plate 665 connected to the bottom plate 664 and extending away from the bottom plate 664 in a direction parallel to the spacer plate 661 and running perpendicular to the side plates 663. The back plate 665 may connect to each of the side plates 663. The back plate 661 may include a label ID 668 that may be removable through a plurality of fasteners 667 (e.g., screws). The label ID 668 may be configured to provide any structural and identity-based information about the direct-attachment connector 332 or any equipment attached thereto. The label ID 668 may include any known bar code, a radio frequency ID (RFID), a stamped tag, and others.

While FIG. 6 depicts the direct-attachment connector 332 having a generally triangular prismatic shape, this is only one embodiment. The direct-attachment connector 332 may have any known general shape, including, but not limited to, a cube, a cuboid, a cylinder, a sphere, a cone, a pyramid, a torus, a hemisphere, a polyhedron, a triangular prism, a pentagonal prism, a hexagonal prism, a rectangular prism, mixtures thereof, and others. The direct-attachment connector 332 may have any general size, such as having at least one dimension (e.g., length, width, height, diameter, etc.) that is about 1 inch, or about 2 inches, or about 3 inches, or about 4 inches, or about 5 inches, or about 6 inches, or about 7 inches, or about 8 inches, or about 9 inches, or about 10 inches, or about 11 inches, or about 12 inches, or more, where about includes plus or minus 1 inch. The direct-attachment connector 332 may have any general size, such as having at least one dimension (e.g., length, width, height, diameter, etc.) that is about 1 foot, or about 2 feet, or about 3 feet, or about 4 feet, or about 5 feet, or about 6 feet, or about 7 feet, or about 8 feet, or about 9 feet, or about 10 feet, or about 11 feet, or about 12 feet, or more, where about includes plus or minus 1 foot. For example, a housing may have a cube shape, a height of about 4 feet, a length of about feet, and a width of about 4 feet. The direct-attachment connector 332 may be made of any metal (e.g., steel) or polymer (e.g., polyethylene). For example, the direct-attachment connector 332 may be made of a polymer including a polyethylene, a polystyrene, a polyurethane, a nylon, a polypropylene, a polyethylene terephthalate, a polymethylmethacrylate, a polyacrylonitrile, a polyvinyl chloride, a polycarbonate, a silicone, a polyester, mixtures thereof, and copolymers thereof. The direct-attachment connector 332 may be made of a metal including a steel, a titanium, a brass, a copper, a lead, an iron, a bronze, an aluminum, a carbon steel, mixtures thereof, and alloys thereof.

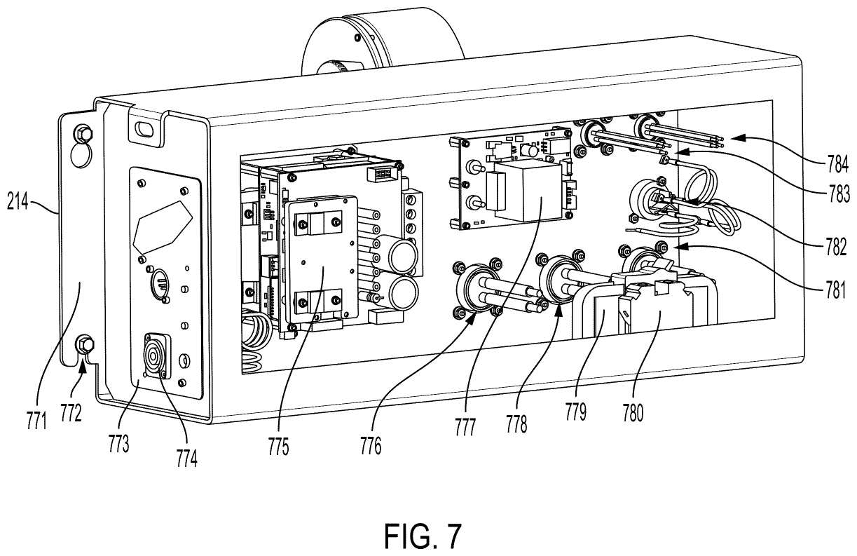

FIG. 7 illustrates a front perspective of a telescopic forklift rotator system controller module 214. The controller module 214 may include a central processing unit and may be configured to control any mechanical aspects of the telescopic forklift rotator system, such as the starting and stopping of any moving components as well as the speed or acceleration in which each component moves. The controller module 214 may include a control enclosure weld 771 and one or more flange bolts 772, which may each provide a means to attach the controller module 214 to a frame 100 of the disclosed telescopic forklift rotator system. The controller module 214, as shown in FIG. 7 may include an AC module 773, a power plug 774, a complete electronic drive 775, a tilt motor connector assembly 776, an e-stop relay assembly 777, and a pan motor connector assembly 778. The controller module 214 may include a breaker TMC 779, a terminal block 780, a battery connector 781, a power out connector 782, a limit connector 783, and an E-stop connector 784. Each of these components of the controller module 214 may work together to control the telescopic forklift rotator system components.

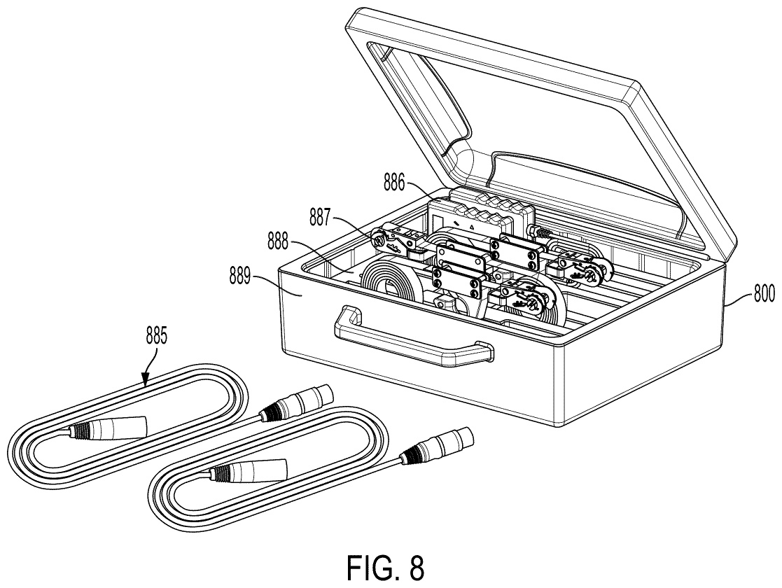

FIG. 8 illustrates a side perspective of a telescopic forklift rotator system accessory case 800. The accessory case 800 may include components for coupling (power and data cable, hand control), and managing (cable guides) the telescopic forklift rotator system. The accessory case 800 may include a wired controller 801, a wireless controller (not shown), a cable guide 886, data cable 885, and a foam insert 888. As shown in FIG. 8, each of the components of the accessory case 800 may be stored in a case 889. In some embodiments, the accessory case 800 may include data cables 805, such as 80 ft data cables 885. The accessory case 800 may be made of any metal (e.g., steel) or polymer (e.g., polyethylene).

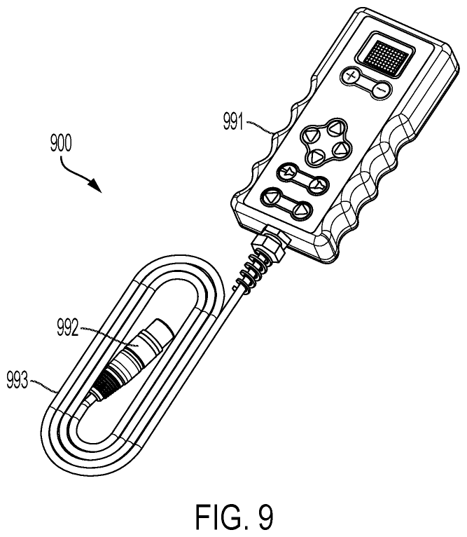

FIG. 9 illustrates a front perspective of a telescopic forklift rotator system wired controller assembly 900. As shown in FIG. 9, the wired controller assembly 900 may include a controller 991 having various buttons that control various aspects of the movement of the telescopic forklift rotator system. For example, the controller 991 may include buttons such as an emergency stop button, direction control buttons, speed control buttons, hold to unlock buttons. The controller 991 may control a rotation of a tilt drive assembly relative to a frame, a rotation of a rotatable mount relative to the frame, or both. The controller 991 may include a display screen for setting speed, reading motor torque and/or power (watts) usage and battery levels. The controller 991 may be coupled to a cable 993 that ends in a XLR five pin connector 992 for attaching directly to the telescopic forklift rotator system, such as to the controller module 214. The cable 993 may be any length ranging from about 1 foot to about 100 feet, or more. For example, the cable may be about 1 foot, or about 5 feet, or about 10 feet, or about 15 feet, or about 20 feet, or about 25 feet, or about 30 feet, or about 35 feet, or about 40 feet, or about 45 feet, or about 50 feet, or about 55 feet, or about 60 feet, or about 65 feet, or about 70 feet, or about 75 feet, or about 80 feet, or about 85 feet, or about 90 feet, or about 95 feet, or about 100 feet, where about includes plus or minus 2.5 feet. In some embodiments, the controller 991 may be wireless. The controller 991 may be used by an operator near the telescopic forklift rotator system or remotely. For example, the controller 991 may wirelessly communicate with a controller module to control all components of the telescopic forklift rotator system.

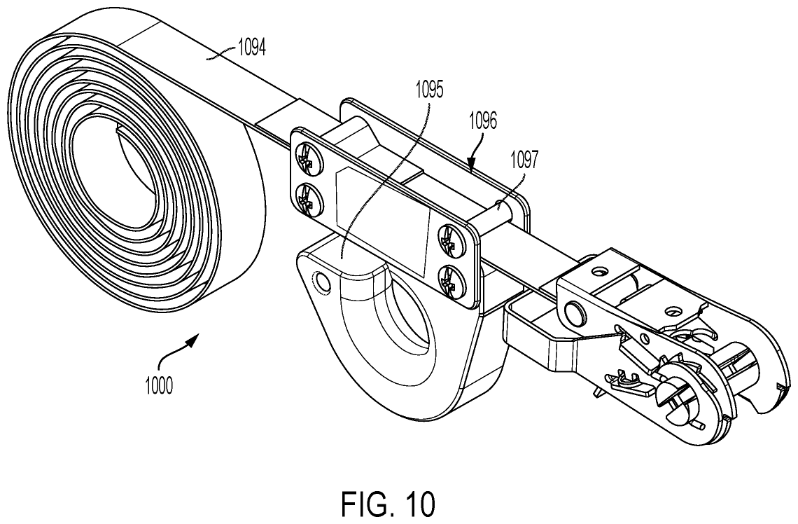

FIG. 10 illustrates a front perspective of a cable guide 1000. The cable guide 1000 may include a ratchet strap 1094, a cable guide hook 1095, a cable guide side plate 1096, and a barrel bolt 1097. The cable guide 1000 may be a part of a cable management system primarily used to route cables along a length of a boom while maintaining clearance from moving parts. These omni directional guides are designed to fit various standard boom configurations. In some embodiments, the cable guide 1000 may fasten various power cables and data cables to any component of the disclosed telescopic forklift rotator system. The data cables and power cables may supply either of data or power to any component of the telescopic forklift rotator system. For example, the cable guide hook 1095 may be configured to receive any of power cables and data cables and then the ratchet strap 1094 may secure to any component of the telescopic forklift rotator system, thereby securing the power cables and/or data cables to the telescopic forklift.

The figures and descriptions provided herein may have been simplified to illustrate aspects that are relevant for a clear understanding of the herein described devices, systems, and methods, while eliminating, for the purpose of clarity, other aspects that may be found in typical similar devices, systems, and methods. Those of ordinary skill may recognize that other elements and/or operations may be desirable and/or necessary to implement the devices, systems, and methods described herein. But because such elements and operations are well known in the art, and because they do not facilitate a better understanding of the present disclosure, a discussion of such elements and operations may not be provided herein. However, the present disclosure is deemed to inherently include all such elements, variations, and modifications to the described aspects that would be known to those of ordinary skill in the art.

The terminology used herein is for the purpose of describing particular example embodiments only and is not intended to be limiting. For example, as used herein, the singular forms “a”, “an” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

Although the terms first, second, third, etc., may be used herein to describe various elements, components, regions, layers and/or sections, these elements, components, regions, layers and/or sections should not be limited by these terms. These terms may be only used to distinguish one element, component, region, layer or section from another element, component, region, layer or section. That is, terms such as “first,” “second,” and other numerical terms, when used herein, do not imply a sequence or order unless clearly indicated by the context. Reference in the specification to “one implementation” or “an implementation” means that a particular feature, structure, or characteristic described in connection with the implementation is included in at least one implementation of the disclosure. The appearances of the phrase “in one implementation,” “in some implementations,” “in one instance,” “in some instances,” “in one case,” “in some cases,” “in one embodiment,” or “in some embodiments” in various places in the specification are not necessarily all referring to the same implementation or embodiment.

Finally, the above descriptions of the implementations of the present disclosure have been presented for the purposes of illustration and description. It is not intended to be exhaustive or to limit the present disclosure to the precise form disclosed. Many modifications and variations are possible in light of the above teaching. It is intended that the scope of the present disclosure be limited not by this detailed description, but rather by the claims of this application. As will be understood by those familiar with the art, the present disclosure may be embodied in other specific forms without departing from the spirit or essential characteristics thereof. Accordingly, the present disclosure is intended to be illustrative, but not limiting, of the scope of the present disclosure, which is set forth in the following claims.

What is claimed is:

1. A telescopic forklift rotator system comprising:
(a) a frame comprising a top plate; a bottom plate positioned opposite the top plate and connected to the top plate by a plurality of side plates; and a gusset connecting the side plates, wherein the frame is configured to house each component of the telescopic forklift rotator system, and wherein each side wall comprises a hole configured to secure a tilt drive assembly to the frame;
(b) the tilt drive assembly comprising a tilt output left arm connected to a tilt output right arm through a shaft, each of the tilt output left arm and tilt output right arm comprising a tilt connector, wherein the tilt drive assembly provides a first axis of rotation for the tilt drive assembly relative to the frame; and
(c) a rotatable mount extending from the top plate in a direction pointing away from the bottom plate, wherein the rotatable mount provides a second axis of rotation for the rotatable mount relative to the frame.

2. The telescopic forklift rotator system according to claim 1, wherein each of the tilt output left arm and tilt output right arm further comprises two or more connectors configured to secure the tilt drive assembly to a truss.

3. The telescopic forklift rotator system according to claim 1, further comprising;
a motor mechanically connected to the frame, the tilt drive, and the rotatable mount; the motor configured to:
provide mechanical power for rotating the truss relative to the frame; and
provide mechanical power for rotating the rotatable mount relative to the frame.

4. The telescopic forklift rotator system according to claim 1,
wherein the rotatable mount comprises a cylindrical body and at least one bolt connection port.

5. The telescopic forklift rotator system according to claim 1, further comprising a direct-attachment connector attached to the rotatable mount.

6. The telescopic forklift rotator system according to claim 5, wherein the direct-attachment connector comprises:
a bottom plate connected to the rotatable mount through at least one bolt;
a spacer plate connected to and extending outward from the bottom plate; and
a pair of side plates connected to and extending outward form the bottom plate in a same direction as the spacer plate while the spacer plate runs perpendicular to and connects the pair of side plates, the pair of side plates each comprising a hook.

7. The telescopic forklift rotator system according to claim 1, further comprising a fork-secure connector attached to the rotatable mount.

8. The telescopic forklift rotator system according to claim 7, wherein the fork-secure connector comprises:
a rectangular prismatic frame comprising a bottom surface that connects to the rotatable mount;
a plurality of fork plate gussets protruding outward from a top surface of the rectangular prismatic frame; and
at least one tie down lug protruding outward from a side of the rectangular prismatic frame in a direction pointing away from the bottom surface, the tie down lug configured to attach to a chain.

9. The telescopic forklift rotator system according to claim 3, further comprising a battery attached to an inside surface of the frame and configured to provide electrical power to the motor.

10. The telescopic forklift rotator system according to claim 1, further comprising a controller module attached to an inside surface of the frame and configured to provide a user with control over each component of the telescopic forklift rotator system.

11. A telescopic forklift rotator system comprising:
(a) a frame comprising a top plate; a bottom plate positioned opposite the top plate and connected to the top plate by a plurality of side plates; and a gusset connecting the side plates, wherein the frame is configured to house each component of the telescopic forklift rotator system, and wherein each side wall comprises a hole configured to secure a tilt drive assembly to the frame;
(b) the tilt drive assembly comprising a tilt output left arm connected to a tilt output right arm through a shaft, each of the tilt output left arm and tilt output right arm comprising a tilt connector, wherein the tilt drive assembly provides a first axis of rotation for the tile drive assembly relative to the frame;
(c) a rotatable mount extending from the top plate in a direction pointing away from the bottom plate, wherein the rotatable mount comprises a cylindrical body and at least one bolt connection port and provides a second axis of rotation for the rotatable mount relative to the frame; and
(d) a connector attached to the rotatable mount through the bolt connection port and configured to attach the telescopic forklift rotator system to a telescopic forklift.

12. The telescopic forklift rotator system according to claim 11, wherein the connector comprises a fork-secure connector.

13. The telescopic forklift rotator system according to claim 12, wherein the fork-secure connector comprises:
a rectangular prismatic frame comprising a bottom surface that connects to the rotatable mount;
a plurality of fork plate gussets protruding outward from a top surface of the rectangular prismatic frame; and
at least one tie down lug protruding outward from a side of the rectangular prismatic frame in a direction pointing away from the bottom surface, the tie down lug configured to attach to a chain.

14. The telescopic forklift rotator system according to claim 11, wherein the connector comprises a direct-attachment connector.

15. The telescopic forklift rotator system according to claim 14, wherein the direct-attachment connector comprises:
a bottom plate connected to the rotatable mount through at least one bolt;
a spacer plate connected to and extending outward from the bottom plate; and
a pair of side plates connected to and extending outward form the bottom plate in a same direction as the spacer plate while the spacer plate runs perpendicular to and connects the pair of side plates, the pair of side plates each comprising a hook.

16. The telescopic forklift rotator system according to claim 11, wherein each of the tilt output left arm and tilt output right arm further comprises two or more connectors configured to secure the tilt drive assembly to a truss.

17. The telescopic forklift rotator system according to claim 11, further comprising; a motor mechanically connected to the frame, the tilt drive, and the rotatable mount.

18. The telescopic forklift rotator system according to claim 17, wherein, the motor is configured to:
provide mechanical power for rotating the truss relative to the frame; and
provide mechanical power for rotating the rotatable mount relative to the frame.

19. The telescopic forklift rotator system according to claim 11, further comprising a controller module attached to an inside surface of the frame and configured to provide a user with control over each component of the telescopic forklift rotator system.

20. The telescopic forklift rotator system according to claim 11, further comprising a battery attached to an inside surface of the frame, wherein the battery is configured to provide electrical power to the motor.
